(19) United States
(12) Patent Application Publication
(10) Pub. No.: US 2024/0268485 A1
(43) Pub. Date: Aug. 15, 2024

(54) METHOD AND SYSTEM FOR FORMING AN AEROSOL-GENERATING COMPONENT OF AN AEROSOL-GENERATING SYSTEM

(71) Applicant: PHILIP MORRIS PRODUCTS S.A., Neuchatel (CH)

(72) Inventor: Irene Taurino, Leuven (BE)

(21) Appl. No.: 18/567,656

(22) PCT Filed: Jun. 16, 2022
(86) PCT No.: PCT/EP2022/066530

§ 371 Date: Dec. 6, 2023

(30) Foreign Application Priority Data
Jun. 17, 2021 (EP) 21180169.1

(51) Int. Cl. A24F 40/70; A24B 15/167; A24F 40/20; A24F 40/46; C09D 5/44; C25D 13/12; C25D 13/20; C25F 1/00

(52) U.S. Cl. CPC A24F 40/70; A24B 15/167; A24F 40/20; A24F 40/46; C09D 5/448; C25D 13/12; C25D 13/20; C25F 1/00

(57) ABSTRACT

A method of forming an aerosol-generating component of an aerosol-generating system, and a system for forming an aerosol-generating component of an aerosol-generating system, the method comprising: submerging at least a portion of a heating element (1) in a deposition liquid (6): submerging at least a portion of an auxiliary electrode (4) in the deposition liquid (6): and supplying a voltage between the heating element (1) and the auxiliary electrode (4) to deposit an aerosol-forming substrate on the heating element (1) by electrophoretic deposition.

The present disclosure relates to systems for forming an aerosol-generating component of an aerosol-generating system, and methods of forming an aerosol-generating component of an aerosol-generating system.

There are many different types of personal vaporisers and heat-not-burn systems available that generate an inhalable aerosol from an aerosol-forming substrate. Some of these systems heat a liquid composition, others heat a solid tobacco mixture, and some heat both a liquid composition and a solid substrate. Some available systems heat the aerosol-forming substrate by conduction of heat from a heating element to an aerosol-forming substrate. Most commonly this is achieved by passing an electrical current through an electrically resistive heating element, giving rise to Joule heating of the heating element. Inductive heating systems have also been proposed, in which Joule heating occurs as a result of eddy currents induced in a susceptor heating element.

Some aerosol-generating system comprise aerosol-generating components that are disposable. For example, some aerosol-generating systems comprise cartridges including both an aerosol-forming substrate and a heating element. In these aerosol-generating systems, the heating element is disposed after the aerosol-generating substrate in the cartridge has been consumed.

It would be desirable to provide an aerosol-generating system with a heating element that is able to be reused. This would reduce the cost of operating the aerosol-generating system, and reduce waste. It would also be desirable to provide an aerosol-generating system with a precise volume of aerosol-forming substrate, in close proximity to the heating element, in order to improve control of the volume and characteristics of aerosol generated by the aerosol-generating system.

According to the present disclosure, there is provided a method of forming an aerosol-generating component of an aerosol-generating system. The method may comprise depositing an aerosol-forming substrate on a heating element by electrophoretic deposition.

The method may comprise submerging at least a portion of an auxiliary electrode in a deposition liquid. The method may further comprise submerging at least a portion of a heating element in the deposition liquid. The method may further comprise supplying a voltage between the heating element and the auxiliary electrode to deposit an aerosol-forming substrate on the heating element by electrophoretic deposition.

According to the present disclosure, there is provided a system for forming an aerosol-generating component of an aerosol-generating system. The system may comprise a heating element. The system may comprise a deposition liquid. The system may comprise an auxiliary electrode. The system may be configured to supply a voltage between the heating element and the auxiliary electrode to deposit an aerosol-forming substrate on the heating element by electrophoretic deposition when at least a portion of the heating element and at least a portion of the auxiliary electrode are submerged in the deposition liquid.

Advantageously, electrical deposition of the aerosol-forming substrate on the heating element is relatively low cost and straightforward to perform, such that it does not need to be performed in a factory setting, and as such, a user of the aerosol-generating system may be able to deposit aerosol-forming substrate by electrophoretic deposition onto a heating element of an aerosol-generating system at home.

Advantageously, depositing an aerosol-forming substrate on a heating element of an aerosol-generating system by electrophoretic deposition may enable the heating element to be reused once the existing aerosol-forming substrate in the aerosol-generating system has been depleted.

Advantageously, depositing an aerosol-forming substrate on a heating element of an aerosol-generating system by electrophoretic deposition may enable the aerosol-forming substrate to be held in close proximity to the heating element, facilitating transfer of heat from the heating element to the aerosol-forming substrate.

Advantageously, depositing an aerosol-forming substrate on a heating element of an aerosol-generating system by electrophoretic deposition may enable precise control of the thickness and the volume of aerosol-forming substrate provided on a heating element of the aerosol-generating system. This may, in turn, enable the rate, volume and characteristics of the aerosol generated by the aerosol-generating system to be precisely controlled.

Advantageously, depositing an aerosol-forming substrate on a heating element by electrophoretic deposition may reduce the risk of the aerosol-forming substrate escaping from the aerosol-generating system, such as a liquid aerosol-forming substrate leaking from an aerosol-generating system before it has been heated to generate an aerosol.

As used herein, the term “aerosol-forming substrate” relates to a substrate capable of releasing volatile compounds that can form an aerosol. Such volatile compounds may be released by heating the aerosol-forming substrate. An aerosol-forming substrate is typically part of an aerosol-generating article. Preferably, the aerosol that is generated by the aerosol-forming substrate is directly inhalable by a user drawing or puffing on the aerosol-generating system.

As used herein, the term “aerosol-generating component” refers to a component of an aerosol-generating system comprising a heating element and an aerosol-forming substrate. For example, an aerosol-generating component may be a cartridge comprising a heating element and an aerosol-forming substrate deposited on the heating element, which is configured to be removably couplable to an aerosol-generating device. For example, an aerosol-generating component may be a heating element of an aerosol-generating device, and an aerosol-forming substrate deposited on the heating element, wherein the heating element is an integral component of the aerosol-generating device.

As used herein, the term “aerosol-generating device” refers to a device that interacts with an aerosol-forming substrate to generate an aerosol. In some embodiments, the heating element is an integral part of the aerosol-generating device. In other embodiments, the heating element may be removably couplable to the aerosol-generating device. Preferably, an aerosol-generating device comprises a power supply arranged to supply power to the heating element to heat the aerosol-forming substrate deposited on the heating element to generate an aerosol.

As used herein, the term “aerosol-generating system” refers to a combination of an aerosol-generating device, a heating element and an aerosol-forming substrate. In an aerosol-generating system, the aerosol-forming substrate, the heating element, and the aerosol-generating device cooperate to generate an aerosol.

The inventors have realised that it is possible to form an aerosol-generating component of an aerosol-generating system by depositing an aerosol-forming substrate on a heating element by electrophoretic deposition.

As used herein, the term “deposit” an aerosol-forming substrate on the heating element means to apply the aerosol-forming substrate as a coating on the outer surface of the heating element, rather than the aerosol-forming substrate being a separate discrete part that is attached to or placed in contact with the heating element.

As used herein, the term “electrophoretic deposition” refers to a process in which particles, typically colloidal particles, in the deposition liquid migrate under the influence of an electric field (electrophoresis) between a working electrode and an auxiliary electrode, and are deposited on a surface of the working electrode. In this disclosure, when the heating element is at least partially submerged in the deposition liquid, the heating element acts as a working electrode.

The method of forming an aerosol-generating component comprises: submerging at least a portion of an auxiliary electrode in a deposition liquid; submerging at least a portion of a heating element in the deposition liquid; and supplying a voltage between the heating element and the auxiliary electrode. The voltage between the heating element and the auxiliary electrode establishes an electric field in the deposition liquid. Charged particles in the deposition liquid migrate under the influence of the electric field to the heating element, where they are deposited and form a coating of aerosol-forming substrate on a surface of the heating element.

Electrophoretic deposition of the aerosol-forming substrate on the heating element differs from mechanical application, such as by brushing or dipping the heating element in the aerosol-forming substrate. Advantageously, electrophoretic deposition of the aerosol-forming substrate on the heating element enables improved control over the thickness, volume and distribution of the aerosol-forming substrate deposited on the heating element, compared to mechanical methods of application.

The heating element may take any suitable form. The heating element may be substantially planar. The heating element may be a wire. The heating element may be a coil.

In some embodiments, at least a portion of the heating element is arranged on a substrate comprising an electrically insulative material. Advantageously, this may improve the structural rigidity of the heating element. As used herein, the term “electrically insulative” refers to materials having an electrical resistivity of at least 1×10⁴ ohm metres (Ω·m), at twenty degrees Celsius.

In some embodiments, the heating element comprises a plurality of heating elements. Advantageously, providing a plurality of heating elements may enable the aerosol-generating system to provide improved control of aerosol generation. For example, each one of the plurality of heating elements may be selectively heated, such that aerosol may be generated at different rates depending on the number of heating elements being heated.

Where the heating element comprises a plurality of heating elements, the step of submerging at least a portion of a heating element in the deposition liquid comprises submerging at least a portion of each of a plurality of heating elements in the deposition liquid

The plurality of heating elements may be arranged to form an array, wherein each heating element is spaced from the other heating elements. At least a portion of each of the plurality of heating elements may be arranged on a substrate comprising an electrically insulative material.

Each of the plurality of heating elements may be substantially planar. Each of the plurality of heating elements may be a wire. Each of the plurality of heating elements may be a coil.

The heating element or heating elements may be comprised of any suitable material to enable the aerosol-forming substrate to be deposited on the heating element by electrophoretic deposition. Preferably, the heating element comprises an inert material. Preferably, the heating element comprises platinum. The heating element may comprise gold.

The auxiliary electrode may take any suitable form to enable the aerosol-forming substrate to be deposited on the heating element by electrophoretic deposition. The auxiliary electrode may be comprised of any suitable material to enable the aerosol-forming substrate to be deposited on the heating element by electrophoretic deposition. Preferably, the auxiliary electrode comprises silver. Particularly preferably, the auxiliary electrode comprises silver chloride.

In some preferred embodiments, the system comprises a reference electrode in addition to the auxiliary electrode. In these preferred embodiments, the system may be configured to supply a voltage between the heating element, the auxiliary electrode, and the reference electrode to deposit an aerosol-forming substrate on the heating element by electrophoretic deposition when at least a portion of the heating element, at least a portion of the auxiliary electrode and at least a portion of the reference electrode are submerged in the deposition liquid. In embodiments comprising a counter electrode, a three electrode system is formed by the heating element, which acts as the working electrode, the auxiliary electrode, and the reference electrode. A stable and known voltage may be supplied to the auxiliary electrode. A voltage supplied to the auxiliary electrode may be measured against the voltage supplied to the reference electrode. The rate of electrical deposition of aerosol-forming substrate occurring at the heating element may be determined from the measured voltage between the auxiliary electrode and the reference electrode. The voltage supplied to the auxiliary electrode may then be adjusted in response to the determined rate of electrical deposition of aerosol-forming substrate occurring at the heating element.

In some preferred embodiments, the method of forming an aerosol-generating component comprises submerging at least a portion of a reference electrode in the deposition liquid. In these embodiments, the step of supplying a voltage comprises supplying a voltage between the heating element, the auxiliary electrode, and the reference electrode to deposit an aerosol-forming substrate on the heating element by electrophoretic deposition.

The reference electrode may take any suitable form to enable the aerosol-forming substrate to be deposited on the heating element by electrophoretic deposition. The reference electrode may be comprised of any suitable material to enable the aerosol-forming substrate to be deposited on the heating element by electrophoretic deposition. Preferably, the reference electrode comprises an inert material. Particularly preferably, the reference electrode comprises platinum.

As used herein, the term “deposition liquid” refers to any liquid comprising the desired components for the aerosol-forming substrate, and which enables an aerosol-forming substrate to be deposited on a heating element by electrophoretic deposition.

The deposition liquid may be a solution. The deposition liquid may comprise water. Where the deposition liquid comprises a solution, the solvent of the solution may be water. Preferably, the deposition liquid is a colloid. The colloid may comprise colloidal particles suspended in a liquid

Preferably, the deposition liquid comprises a saccharide. The saccharide may comprise a monosaccharide. Preferably, the saccharide comprises a polysaccharide.

Advantageously, a polysaccharide in the deposition liquid may act as a trapping agent for other components of the deposition liquid. The polysaccharide may encapsulate and trap the other components in the deposition liquid that are desired to form the aerosol-forming substrate. During electrodeposition, the polysaccharide and trapped components of the aerosol-forming substrate may be deposited on the heating element together by electrophoretic deposition. Since the deposited substance comprises the desired components to form the aerosol-forming substrate, the deposited substance forms a coating of the aerosol-forming substrate on the heating element.

The polysaccharide may comprise a cellulose derivative.

Preferably, the polysaccharide comprises sodium alginate (AlgNa). The deposition liquid may comprise sodium alginate in a solution. The alginate in the sodium alginate solution may migrate to the heating element on application of a voltage between the heating element and the auxiliary electrode. Advantageously, the alginate may gelate at the heating element to form a gel coating on the heating element. Even more advantageously, the alginate gel may act as a trapping agent for the desired components of the aerosol-forming substrate that are also present in the deposition liquid. As a result, the desired components for the aerosol-forming substrate that are also present in the deposition liquid may be trapped in the alginate gel that is deposited on the heating element, resulting in the alginate gel deposited on the heating element forming the aerosol-forming substrate.

In some embodiments, the deposition liquid comprises calcium carbonate (CaCO₃). In some preferred embodiments, the deposition liquid comprises sodium alginate (AlgNa) and calcium carbonate (CaCO₃).

In some embodiments, the deposition liquid comprises iron(II) (Fe²⁺). In some preferred embodiments, the deposition liquid comprises sodium alginate and iron(II) (Fe²⁺).

The deposition liquid comprises the desired components for forming the aerosol-forming substrate. Preferably, the deposition liquid comprises at least one aerosol former. The aerosol former may comprise vegetable glycerine. The aerosol former may comprise propylene glycol.

The deposition liquid may comprise an active ingredient. The active ingredient may be nicotine. The deposition liquid may comprise nicotine.

The deposition liquid may comprise other additives and ingredients, such as flavourants. The deposition liquid may comprise menthol.

In some embodiments, the deposition liquid comprises an acid. The acid may comprise lactic acid.

The system comprises a heating element, an auxiliary electrode, and optionally a reference electrode. The heating element, auxiliary electrode, and reference electrode may be configured in various arrangements in accordance with this disclosure.

The heating element forms part of an aerosol-generating component of an aerosol-generating system. The aerosol-generating component comprises the aerosol-forming substrate when the aerosol-forming substrate is deposited on the heating element.

The system may comprise an aerosol-generating device. In some embodiments, the heating element is a separate component to the aerosol-generating device. The heating element may be removably couplable to the aerosol-generating device. In some embodiments, the aerosol-generating device comprises the heating element. The heating element may be an integral part of the aerosol-generating device.

In some embodiments, the aerosol-generating device is configured to receive power from an external power supply. Preferably, the aerosol-generating device comprises a power supply. Preferably, the power supply is arranged to supply power to the heating element. Where the heating element is removably couplable to the aerosol-generating device, the power supply may be arranged to supply power to the heating element when the heating element is coupled to the aerosol-generating device. The aerosol-generating device may be configured to supply power to the heating element to heat the aerosol-forming substrate deposited on the heating element to generate an aerosol from the aerosol-forming substrate. The aerosol-generating device may be configured to supply power to the heating element to deposit the aerosol-forming substrate on the heating element by electrophoretic deposition when at least a portion of the heating element and at least a portion of the auxiliary electrode are submerged in the deposition liquid.

Where the aerosol-generating device comprises the heating element, the step of submerging at least a portion of the heating element in the deposition liquid may comprise submerging at least a portion of the aerosol-generating device in the deposition liquid.

In some embodiments, the aerosol-generating device is configured to removably receive the auxiliary electrode. In some embodiments, the aerosol-generating device comprises the auxiliary electrode. The auxiliary electrode may form an integral part of the aerosol-generating device. Where the aerosol-generating device comprises a power supply, the power supply may be arranged to supply power to the auxiliary electrode.

The aerosol-generating device may be configured to supply power to the auxiliary electrode to deposit the aerosol-forming substrate on the heating element by electrophoretic deposition when at least a portion of the heating element and at least a portion of the auxiliary electrode are submerged in the deposition liquid. The aerosol-generating device may be configured to supply the voltage between the heating element and the auxiliary electrode to deposit the aerosol-forming substrate on the heating element by electrophoretic deposition when at least a portion of the heating element and at least a portion of the auxiliary electrode are submerged in the deposition liquid.

Where the aerosol-generating device comprises the auxiliary electrode, the step of submerging at least a portion of the auxiliary electrode in the deposition liquid may comprise submerging at least a portion of the aerosol-generating device in the deposition liquid.

Where the system comprises a reference electrode, the aerosol-generating device may be configured to removably receive the reference electrode. In some embodiments, the aerosol-generating device comprises the reference electrode. The reference electrode may form an integral part of the aerosol-generating device. Where the aerosol-generating device comprises a power supply, the power supply may be arranged to supply power to the reference electrode.

The aerosol-generating device may be configured to supply power to the reference electrode to deposit the aerosol-forming substrate on the heating element by electrophoretic deposition when at least a portion of the heating element, at least a portion of the auxiliary electrode, and at least a portion of the reference electrode are submerged in the deposition liquid. The aerosol-generating device may be configured to supply the voltage between the heating element, the auxiliary electrode and the reference electrode to deposit the aerosol-forming substrate on the heating element by electrophoretic deposition when at least a portion of the heating element, at least a portion of the auxiliary electrode, and at least a portion of the reference electrode are submerged in the deposition liquid.

Where the system comprises a reference electrode, and the aerosol-generating device comprises the reference electrode, the step of submerging at least a portion of the reference electrode in the deposition liquid may comprise submerging at least a portion of the aerosol-generating device in the deposition liquid.

According to the present disclosure, there is provided an aerosol-generating device comprising a heating element and an auxiliary electrode. The aerosol-generating device may be configured to supply a voltage between the heating element and the auxiliary electrode. The aerosol-generating device may comprise a power supply arranged to supply power to the heating element. The power supply may also be arranged to supply power to the auxiliary electrode. The aerosol-generating device may further comprise a reference electrode. The aerosol-generating device may be configured to supply a voltage between the heating element, the auxiliary electrode and the reference electrode. Where the aerosol-generating device comprises a power supply, the power supply may be arranged to supply power to the reference electrode.

Preferably, the aerosol-generating device is portable. The aerosol-generating device may be a handheld device. The aerosol-generating device may have a size comparable to a conventional cigar or cigarette. The aerosol-generating device may have a total length between about 30 millimetres and about 150 millimetres. The aerosol-generating device may have an outer diameter between about 5 millimetres and about 30 millimetres. The aerosol-generating device may be a personal vaporiser, an e-cigarette or heat-not-burn device.

In some embodiments, the aerosol-generating component is a separate component to an aerosol-generating device. The aerosol-generating component may be removably couplable to the aerosol-generating device. An aerosol-generating component that is a separate component to an aerosol-generating device, and is removably couplable to the aerosol-generating device, may be referred to as a cartridge of an aerosol-generating system.

The system may further comprise a cartridge. The cartridge may be configured to be removably couplable with an aerosol-generating device to form an aerosol-generating system. The cartridge may comprise the heating element. The heating element may be an integral part of the cartridge. The cartridge may comprise the heating element and the aerosol-forming substrate deposited on the heating element. The aerosol-generating device may be configured to be electrically coupled to the heating element in the cartridge when the cartridge is coupled to the aerosol-generating device. When the cartridge is coupled to the aerosol-generating device, the aerosol-generating device may be configured to supply power to the heating element to heat the aerosol-forming substrate deposited on the heating element to generate an aerosol from the aerosol-forming substrate. Preferably, the aerosol-generating device comprises a power supply arranged to supply power to the heating element when the cartridge is coupled to the aerosol-generating device.

Where the cartridge comprises the heating element, the step of submerging at least a portion of the heating element in the deposition liquid may comprise submerging at least a portion of the cartridge in the deposition liquid.

In some embodiments, the cartridge comprises the auxiliary electrode. The auxiliary electrode may form an integral part of the cartridge. The aerosol-generating device may be configured to be electrically coupled to the auxiliary electrode in the cartridge when the cartridge is coupled to the aerosol-generating device. When the cartridge is coupled to the aerosol-generating device, the aerosol-generating device may be configured to supply power to the auxiliary electrode. Where the aerosol-generating device comprises a power supply, the power supply may be arranged to supply power to the auxiliary electrode when the cartridge is coupled to the aerosol-generating device.

Where the cartridge comprises the auxiliary electrode, the step of submerging at least a portion of the auxiliary electrode in the deposition liquid may comprise submerging at least a portion of the cartridge in the deposition liquid.

Where the system comprises a reference electrode, the cartridge may comprise the auxiliary electrode. The reference electrode may form an integral part of the cartridge. The aerosol-generating device may be configured to be electrically coupled to the reference electrode in the cartridge when the cartridge is coupled to the aerosol-generating device. When the cartridge is coupled to the aerosol-generating device, the aerosol-generating device may be configured to supply power to the reference electrode. Where the aerosol-generating device comprises a power supply, the power supply may be arranged to supply power to the reference electrode when the cartridge is coupled to the aerosol-generating device.

Where the system comprises a reference electrode, and the cartridge comprises the reference electrode, the step of submerging at least a portion of the reference electrode in the deposition liquid may comprise submerging at least a portion of the cartridge in the deposition liquid.

The cartridge may comprise a housing. The heating element may be fixed in the housing of the cartridge. The housing of the cartridge and the heating element may be integrally connected.

In some preferred embodiments, the cartridge comprises a mouthpiece. A mouthpiece enables a user to puff on the aerosol-generating system to receive aerosol generated by the aerosol-generating system from the heated aerosol-forming substrate.

In some preferred embodiments, the system comprises a deposition device. Where the system comprises a deposition device, the deposition device holds the deposition liquid.

The deposition device may define a cavity for holding the deposition liquid. The deposition device may comprise a housing defining a cavity for holding the deposition liquid.

The deposition device may be configured to receive at least a portion of the heating element. Where the system comprises a cartridge comprising the heating element, the deposition device may be configured to receive at least a portion of the cartridge. Where the system comprises an aerosol-generating device comprising the heating element, the deposition device may be configured to receive at least a portion of the aerosol-generating device.

In some embodiments, the deposition device merely provides a vessel for holding the deposition liquid. For example, in systems comprising an aerosol-generating device comprising the heating element, the auxiliary electrode, and a power supply arranged to supply a voltage between the heating element and the auxiliary electrode, the deposition device may be provided to hold the deposition liquid.

In some embodiments, the deposition device is configured to receive power from an external power supply. Preferably, the deposition device comprises a power supply. In some preferred embodiments, the deposition device may be configured to be electrically coupled to the heating element. In these embodiments, the deposition device may be configured to supply power to the heating element when the heating element is electrically coupled to the deposition device.

In some embodiments, the deposition device comprises the auxiliary electrode. The deposition device may define a cavity holding the deposition liquid, and the auxiliary electrode may be at least partially arranged in the cavity. The deposition device may be configured to supply power to the auxiliary electrode. Where the deposition device does not comprise the auxiliary electrode, the deposition device may be configured to be electrically coupled to the auxiliary electrode. In these embodiments, the deposition device may be configured to supply power to the auxiliary electrode when the heating element is electrically coupled to the deposition device.

In some embodiments where the system comprises a reference electrode, the deposition device comprises the reference electrode. Where the deposition device defines a cavity holding the deposition liquid, the reference electrode may be at least partially arranged in the cavity. The deposition device may be configured to supply power to the reference electrode. Where the deposition device does not comprise the reference electrode, the deposition device may be configured to be electrically coupled to the reference electrode. In these embodiments, the deposition device may be configured to supply power to the reference electrode when the heating element is electrically coupled to the deposition device.

The deposition device may comprise one or more electrical contact pads. The one or more electrical contact pads may provide an electrical connection between the heating element and the deposition device. Where the deposition device does not comprise the auxiliary electrode, the one or more electrical contact pads may provide an electrical connection between the auxiliary electrode and the deposition device. Where the system comprises a reference electrode and the deposition device does not comprise the reference electrode, the one or more electrical contact pads may provide an electrical connection between the reference electrode and the deposition device.

According to the present disclosure, there is provided a deposition device comprising a housing defining a cavity holding a deposition liquid. The deposition device may comprise an auxiliary electrode arranged in the cavity and at least partially submerged in the deposition liquid. The deposition device may comprise an electrical connector arranged in the cavity and at least partially submerged in the deposition liquid. The electrical connector may be configured to be electrically coupled to a heating element received in the cavity and at least partially submerged in the deposition liquid. The deposition device may comprise a power supply. The power supply may be arranged to supply a voltage between the electrical connector and the auxiliary electrode. In other words, the deposition device may be configured to supply a voltage between a heating element electrically coupled to the electrical connector and the auxiliary electrode. In some embodiments, the deposition device comprises a reference electrode arranged in the cavity and at least partially submerged in the deposition liquid. Where the deposition device comprises a power supply, the power supply may be arranged to supply a voltage between the electrical connector, the auxiliary electrode, and the reference electrode. In other words, the deposition device may be configured to supply a voltage between a heating element electrically coupled to the electrical connector, the auxiliary electrode, and the reference electrode.

The system is configured to supply a voltage between the heating element and the auxiliary electrode. Where the system comprises a reference electrode, the system is configured to supply a voltage between the heating element, the auxiliary electrode, and the reference electrode.

In some embodiments, the system is configured to connect to an external power supply, such as a mains power supply, to supply a voltage between the heating element, the auxiliary electrode, and optionally the reference electrode.

In some preferred embodiments, the system comprises a power supply. The power supply may be arranged to supply power to the heating element. The power supply may be arranged to supply power to the auxiliary electrode. The power supply may be arranged to supply the voltage between the heating element and the auxiliary electrode. Where the system comprises a reference electrode, the power supply may be arranged to supply power to the reference electrode. The power supply may be arranged to supply the voltage between the heating element, the auxiliary electrode and the reference electrode.

In embodiments comprising an aerosol-generating device, preferably the aerosol-generating device comprises a power supply. In embodiments comprising a deposition device, preferably the deposition device comprises a power supply. The aerosol-generating device may comprise a power supply, and the deposition device may comprise a power supply.

The power supply may be a DC power supply. The power supply may comprise at least one battery. The at least one battery may include a rechargeable lithium ion battery. As an alternative, the power supply may be another form of charge storage device, such as a capacitor.

Preferably, the system comprises a controller. The controller may be configured to control the supply of power to the heating element. The controller may be configured to control the supply of power to the auxiliary electrode. The controller may be configured to control the supply of voltage between the heating element and the auxiliary electrode. Where the system comprises a reference electrode, the controller may be configured to control the supply of power to the reference electrode. In these embodiments, the controller may be configured to control the supply of voltage between the heating element, the auxiliary electrode and the reference electrode.

In embodiments comprising an aerosol-generating device, preferably the aerosol-generating device comprises a controller. In embodiments comprising a deposition device, preferably the deposition device comprises a controller. The aerosol-generating device may comprise a controller and the deposition device may comprise a controller.

The controller may comprise a microprocessor, a programmable microprocessor, a microcontroller, or an application specific integrated chip (ASIC) or other electronic circuitry capable of providing control. The controller may comprise further electronic components. For example, in some embodiments, the controller may comprise any of: sensors, switches, display elements. The controller may comprise an RF power sensor. The controller may comprise a power amplifier.

In embodiments comprising an aerosol-generating device, preferably the aerosol-generating device comprises a controller. The controller may be configured to control the supply of power to the heating element to heat the aerosol-forming substrate deposited on the heating element to generate an aerosol from the aerosol-forming substrate. Where the aerosol-generating device comprises the heating element and the auxiliary electrode, the controller may be configured to control the supply of voltage between the heating element and the auxiliary electrode to deposit the aerosol-forming substrate on the heating element by electrophoretic deposition when at least a portion of the heating element and at least a portion of the auxiliary electrode are submerged in the deposition liquid. Where the aerosol-generating device comprises the heating element, the auxiliary electrode and a reference electrode, the controller may be configured to control the supply of the voltage between the heating element, the auxiliary electrode and the reference electrode to deposit the aerosol-forming substrate on the heating element by electrophoretic deposition when at least a portion of the heating element, at least a portion of the auxiliary electrode, and at least a portion of the reference electrode are submerged in the deposition liquid.

In embodiments comprising a deposition device, preferably the deposition device comprises a controller. Where the deposition device comprises the auxiliary electrode, the controller may be configured to control the supply of voltage between the heating element and the auxiliary electrode to deposit the aerosol-forming substrate on the heating element by electrophoretic deposition when at least a portion of the heating element and at least a portion of the auxiliary electrode are submerged in the deposition liquid. Where the aerosol-generating device comprises the auxiliary electrode and a reference electrode, the controller may be configured to control the supply of voltage between the heating element, the auxiliary electrode and the reference electrode to deposit the aerosol-forming substrate on the heating element by electrophoretic deposition when at least a portion of the heating element, at least a portion of the auxiliary electrode, and at least a portion of the reference electrode are submerged in the deposition liquid.

In some preferred embodiments, the system comprises a cleaner. The cleaner is configured to remove aerosol-forming substrate from the heating element. The cleaner may comprise a cleaning device separate from other components of the system. Where the system comprises a deposition device, preferably the deposition device further comprises the cleaner.

The cleaner may comprise a brush. The cleaner may comprise a scraper.

In some embodiments, the cleaner comprises a cleaning liquid. The cleaning liquid may be any suitable cleaning liquid for removing aerosol-forming substrate from the heating element. For example, the cleaning liquid may comprise an acid. The cleaning liquid may comprise water. In some embodiments, the cleaning liquid is the deposition liquid.

Where the system comprises a deposition device, and the deposition device comprises the cleaner, the deposition device may comprise a cleaning compartment comprising a cleaning cavity configured to receive the heating element. The cleaning cavity may hold the cleaning liquid.

In some embodiments, the deposition device may comprise a cleaning auxiliary electrode arranged in the cleaning cavity and at least partially submerged in the cleaning liquid. The deposition device may be configured to be electrically coupled to the heating element and supply a voltage between the heating element and the cleaning auxiliary electrode when the heating element is received in the cleaning liquid to electrically clean the heating element.

In some embodiments, the cleaning liquid is the deposition liquid, and the deposition device is configured to be electrically coupled to the heating element and supply a voltage between the heating element and the auxiliary electrode when the heating element is received in the cleaning liquid to electrically clean the heating element. Typically, the voltage supplied between the heating element and the auxiliary electrode to clean the heating element is opposite to the voltage supplied between the heating element and the auxiliary electrode to deposit the aerosol-forming substrate on the heating element.

The method of forming the aerosol-generating component may further comprise the step of cleaning the heating element. The step of cleaning the heating element may remove any existing aerosol-forming substrate and any undesirable materials from the surface of the heating element. In some preferred embodiments, the step of cleaning the heating element is performed before the step of submerging the heating element in the deposition liquid. Advantageously, cleaning the heating element before depositing new aerosol-forming substrate on the heating element may improve the contact between the heating element and the aerosol-forming substrate, and may improve the consistency of the aerosol generated from the aerosol-forming substrate.

The step of cleaning the heating element may comprise brushing the heating element with a brush. The step of cleaning the heating element may comprise scraping the heating element with a scraper.

In some embodiments, the step of cleaning the heating element comprises submerging at least a portion of the heating element in a cleaning liquid.

The method may further comprise: submerging a cleaning auxiliary electrode in a cleaning liquid; submerging at least a portion of the heating element in the cleaning liquid; and supplying a voltage between the heating element and the cleaning auxiliary electrode to electrically clean the heating element.

Where the cleaning liquid is the deposition liquid, the step of cleaning the heating element may comprise supplying a voltage between the heating element and the auxiliary electrode to clean the heating element, the voltage supplied between the heating element and the auxiliary electrode to clean the heating element being opposite to the voltage supplied between the heating element and the auxiliary electrode to deposit the aerosol-forming substrate on the heating element by electrophoretic deposition.

According to the disclosure, an aerosol-forming substrate is deposited on a heating element of an aerosol-generating system by electrophoretic deposition. The aerosol-forming substrate may comprise a solid. The aerosol-forming substrate may comprise a liquid. Preferably, the aerosol-forming substrate comprises a gel. The aerosol-forming substrate may comprise any combination of two or more of a solid, a liquid and a gel.

The components of the aerosol-forming substrate are comprised in the deposition liquid before the aerosol-forming substrate is deposited on the heating element. Accordingly, any of the components of the aerosol-forming substrate mentioned below may be comprised in the deposition liquid.

The aerosol-forming substrate may comprise nicotine, a nicotine derivative or a nicotine analogue. The aerosol-forming substrate may comprise one or more nicotine salt. The one or more nicotine salt may be selected from the list consisting of nicotine citrate, nicotine lactate, nicotine pyruvate, nicotine bitartrate, nicotine pectates, nicotine alginates, and nicotine salicylate.

The aerosol-forming substrate may comprise an aerosol former. As used herein, an “aerosol former” is any suitable known compound or mixture of compounds that, in use, facilitates formation of a dense and stable aerosol and that is substantially resistant to thermal degradation at the operating temperature of the aerosol-generating article. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol and glycerine.

The aerosol-forming substrate may further comprise a flavourant. The flavourant may comprise a volatile flavour component. The flavourant may comprise menthol. As used herein, the term ‘menthol’ denotes the compound 2-isopropyl-5-methylcyclohexanol in any of its isomeric forms. The flavourant may provide a flavour selected from the group consisting of menthol, lemon, vanilla, orange, wintergreen, cherry, and cinnamon. The flavourant may comprise volatile tobacco flavour compounds which are released from the substrate upon heating.

In some examples, the aerosol-forming substrate includes one or more sensory-enhancing agents. Suitable sensory-enhancing agents include flavourants and sensation agents, such as cooling agents. Suitable flavourants include natural or synthetic menthol, peppermint, spearmint, coffee, tea, spices (such as cinnamon, clove, ginger, or combination thereof), cocoa, vanilla, fruit flavours, chocolate, eucalyptus, geranium, eugenol, agave, juniper, anethole, linalool, and any combination thereof.

Below, there is provided a non-exhaustive list of non-limiting examples. Any one or more of the features of these examples may be combined with any one or more features of another example, embodiment, or aspect described herein.

1. A method of forming an aerosol-generating component of an aerosol-generating system, the method comprising:
submerging at least a portion of an auxiliary electrode in a deposition liquid;
submerging at least a portion of a heating element in the deposition liquid; and
supplying a voltage between the heating element and the auxiliary electrode to deposit an aerosol-forming substrate on the heating element by electrophoretic deposition.

2. A method according to example 1, wherein the heating element is substantially planar.

3. A method according to example 1, wherein the heating element is a wire.

4. A method according to example 1, wherein the heating element is a coil.

5. A method according to any one of examples 1 to 4, wherein at least a portion of the heating element is arranged on a substrate comprising an electrically insulative material.

6. A method according to any one of examples 1 to 4, wherein the step of submerging at least a portion of a heating element in the deposition liquid comprises submerging at least a portion of each of a plurality of heating elements in the deposition liquid.

7. A method according to example 6, wherein at least a portion of each of the plurality of heating elements is arranged on a substrate comprising an electrically insulative material.

8. A method according to examples 6 or 7, wherein the plurality of heating elements are arranged to form an array, wherein each heating element is spaced from the other heating elements.

9. A method according to examples 6, 7 or 8, wherein each of the plurality of heating elements is substantially planar.

10. A method according to examples 6, 7 or 8, wherein each of the plurality of heating elements is a wire.

11. A method according to examples 6, 7 or 8, wherein each of the plurality of heating elements is a coil.

12. A method according to any one of examples 1 to 11, wherein the deposition liquid is a solution.

13. A method according to any one of examples 1 to 12, wherein the deposition liquid comprises water.

14. A method according to any one of examples 1 to 13, wherein the deposition liquid comprises a saccharide.

15. A method according to example 14, wherein the saccharide comprises a monosaccharide.

16. A method according to examples 14 or 15, wherein the saccharide comprises a polysaccharide.

17. A method according to example 16, wherein the polysaccharide comprises sodium alginate.

18. A method according to example 16, wherein the polysaccharide is a cellulose derivative.

19. A method according to any one of examples 1 to 18, wherein the deposition liquid comprises sodium alginate and calcium carbonate.

20. A method according to any one of examples 1 to 18, wherein the deposition liquid comprises sodium alginate and iron(II).

21. A method according to any one of examples 1 to 20, wherein the deposition liquid comprises a flavourant.

22. A method according to any one of examples 1 to 21, wherein the deposition liquid comprises nicotine.

23. A method according to any one of examples 1 to 22, wherein the deposition liquid comprises an aerosol former.

24. A method according to example 23, wherein the aerosol former comprises vegetable glycerine.

25. A method according to examples 23 or 24, wherein the aerosol former comprises propylene glycol.

26. A method according to any one of examples 1 to 25, wherein the deposition liquid comprises an acid.

27. A method according to example 26, wherein the acid comprises lactic acid.

28. A method according to any one of examples 1 to 27, wherein the auxiliary electrode comprises silver.

29. A method according to any one of examples 1 to 28, wherein the auxiliary electrode comprises silver chloride.

30. A method according to any one of examples 1 to 29, wherein the step of submerging at least a portion of the heating element in the deposition liquid comprises submerging at least a portion of a cartridge of an aerosol-generating system, and wherein the cartridge comprises the heating element.

31. A method according to example 30, wherein the cartridge comprises the auxiliary electrode, and wherein the step of submerging at least a portion of the auxiliary electrode in the deposition liquid comprises submerging at least a portion of the cartridge in the deposition liquid.

32. A method according to examples 30 or 31, wherein the cartridge comprises a mouthpiece.

33. A method according to examples 30, 31 or 32, wherein the cartridge is removably couplable to an aerosol-generating device.

34. A method according to example 33, wherein the aerosol-generating device comprises a power supply arranged to supply power to the heating element when the cartridge is coupled to the aerosol-generating device to heat the aerosol-forming substrate deposited on the heating element to generate an aerosol from the aerosol-forming substrate.

35. A method according to any one of examples 1 to 29, wherein the step of submerging at least a portion of the heating element in the deposition liquid comprises submerging at least a portion of an aerosol-generating device, and wherein the aerosol-generating device comprises the heating element.

36. A method according to example 35, wherein the aerosol-generating device comprises the auxiliary electrode, and wherein the step of submerging at least a portion of the auxiliary electrode in the deposition liquid comprises submerging at least a portion of the aerosol-generating device in the deposition liquid.

37. A method according to examples 35 or 36, wherein the aerosol-generating device comprises a power supply arranged to supply power to the heating element to heat the aerosol-forming substrate deposited on the heating element to generate an aerosol from the aerosol-forming substrate.

38. A method according to examples 34 or 37, wherein the step of supplying a voltage between the heating element and the auxiliary electrode to deposit an aerosol-forming substrate on the heating element by electrophoretic deposition comprises supplying power to the heating element from the power supply of the aerosol-generating device.

39. A method according to examples 34, 37 or 38, wherein the step of supplying a voltage between the heating element and the auxiliary electrode to deposit an aerosol-forming substrate on the heating element by electrophoretic deposition comprises supplying power to the auxiliary electrode from the power supply of the aerosol-generating device.

40. A method according to any one of examples 1 to 39, wherein the method further comprises submerging at least a portion of a reference electrode in the deposition liquid, and wherein the step of supplying a voltage between the heating element and the auxiliary electrode comprises supplying a voltage between the heating element, the auxiliary electrode, and the reference electrode to deposit an aerosol-forming substrate on the heating element by electrophoretic deposition.

41. A method according to any one of examples 34, 37, 38, 39 wherein the method further comprises submerging a reference electrode in the deposition liquid, wherein the step of supplying a voltage between the heating element and the auxiliary electrode comprises supplying a voltage between the heating element, the auxiliary electrode, and the reference electrode to deposit an aerosol-forming substrate on the heating element by electrophoretic deposition, and wherein the step of supplying a voltage between the heating element, the auxiliary electrode and the reference electrode to deposit an aerosol-forming substrate on the heating element by electrophoretic deposition comprises supplying power to the reference electrode from the power supply of the aerosol-generating device.

42. A method according to any one of examples 30 to 34, wherein the method further comprises submerging a reference electrode in the deposition liquid, wherein the step of supplying a voltage between the heating element and the auxiliary electrode comprises supplying a voltage between the heating element, the auxiliary electrode, and the reference electrode to deposit an aerosol-forming substrate on the heating element by electrophoretic deposition, wherein the cartridge comprises the reference electrode, and wherein the step of submerging at least a portion of the reference electrode in the deposition liquid comprises submerging at least a portion of the cartridge in the deposition liquid.

43. A method according to any one of examples 33 to 37, wherein the method further comprises submerging a reference electrode in the deposition liquid, wherein the step of supplying a voltage between the heating element and the auxiliary electrode comprises supplying a voltage between the heating element, the auxiliary electrode, and the reference electrode to deposit an aerosol-forming substrate on the heating element by electrophoretic deposition, wherein the aerosol-generating device comprises the reference electrode, and wherein the step of submerging at least a portion of the reference electrode in the deposition liquid comprises submerging at least a portion of the aerosol-generating device in the deposition liquid.

44. A method according to any one of examples 40 to 43, wherein the reference electrode comprises platinum.

45. A method according to any one of examples 1 to 44, wherein the deposition liquid is held in a deposition device.

46. A method according to any one of examples 1 to 30 or 35, wherein the deposition liquid is held in a deposition device, and the deposition device comprises the auxiliary electrode.

47. A method according to any one of examples 1 to 37, wherein the deposition liquid is held in a deposition device, wherein the deposition device comprises a power supply arranged to supply a voltage between the heating element and the auxiliary electrode, and the step of supplying a voltage between the heating element and the auxiliary electrode to deposit an aerosol-forming substrate on the heating element by electrophoretic deposition comprises supplying a voltage between the heating element and the auxiliary electrode from the power supply of the deposition device.

48. A method according to any one of examples 1 to 30 or 35, wherein the deposition liquid is held in a deposition device, and the deposition device comprises the auxiliary electrode, wherein the deposition device comprises a power supply arranged to supply a voltage between the heating element and the auxiliary electrode, and the step of supplying a voltage between the heating element and the auxiliary electrode to deposit an aerosol-forming substrate on the heating element by electrophoretic deposition comprises supplying a voltage between the heating element and the auxiliary electrode from the power supply of the deposition device.

49. A method according to any one of examples 1 to 39, wherein the deposition liquid is held in a deposition device, wherein the method further comprises submerging a reference electrode in the deposition liquid, wherein the deposition device comprises the reference electrode, and wherein the step of supplying a voltage between the heating element and the auxiliary electrode comprises supplying a voltage between the heating element, the auxiliary electrode, and the reference electrode to deposit an aerosol-forming substrate on the heating element by electrophoretic deposition.

50. A method according to examples 46, 47 or 48, wherein the method further comprises submerging a reference electrode in the deposition liquid, wherein the step of supplying a voltage comprises supplying a voltage between the heating element, the auxiliary electrode, and the reference electrode from the power supply of the deposition device to deposit an aerosol-forming substrate on the heating element by electrophoretic deposition.

51. A method according to examples 49 or 50, wherein the deposition device comprises the auxiliary electrode.

52. A method according to any one of examples 45 to 48, wherein the deposition device comprises a controller configured to control the supply of the voltage between the heating element and the auxiliary electrode.

53. A method according to examples 49, 50 or 51, wherein the deposition device comprises a controller configured to control the supply of the voltage between the heating element, the auxiliary electrode, and the reference electrode.

54. A method according to any one of examples 1 to 53, wherein the method further comprises the step of cleaning the heating element.

55. A method according to example 54, wherein the step of cleaning the heating element is performed before the step of submerging at least a portion of the heating element in the deposition liquid.

56. A method according to examples 54 or 55, wherein the step of cleaning the heating element comprises at least one of brushing the heating element with a brush, and scraping the heating element with a scraper.

57. A method according to any one of examples 54 to 56, wherein the step of cleaning the heating element comprises submerging at least a portion of the heating element in a cleaning liquid.

58. A method according to example 57, wherein the cleaning liquid comprises an acid.

60. A method according to examples 58 or 59, wherein the cleaning solution is a deposition liquid, and the method further comprises:
submerging a cleaning auxiliary electrode in the cleaning liquid;
submerging at least a portion of the heating element in the cleaning liquid; and
supplying a voltage between the heating element and the cleaning auxiliary electrode to electrically clean the heating element.

61. A system for forming an aerosol-generating component of an aerosol-generating system, the system comprising:
a heating element;
a deposition liquid; and
an auxiliary electrode;
   wherein the system is configured to supply a voltage between the heating element and the auxiliary electrode to deposit an aerosol-forming substrate on the heating element by electrophoretic deposition when at least a portion of the heating element and at least a portion of the auxiliary electrode are submerged in the deposition liquid.

62. A system according to example 61, wherein the heating element is substantially planar.

63. A system according to example 61, wherein the heating element is a wire.

64. A system according to example 61, wherein the heating element is a coil.

65. A system according to any one of examples 61 to 64, wherein at least a portion of the heating element is arranged on a substrate comprising an electrically insulative material.

66. A system according to any one of examples 61 to 64, wherein the heating element comprises a plurality of heating elements.

67. A system according to example 66, wherein at least a portion of each of the plurality of heating elements are arranged on a substrate comprising an electrically insulative material.

68. A system according to examples 66 or 67, wherein the plurality of heating elements are arranged to form an array, wherein each heating element is spaced from the other heating elements.

69. A system according to examples 66, 67 or 68, wherein each of the plurality of heating elements is substantially planar.

70. A system according to examples 66, 67 or 68, wherein each of the plurality of heating elements is a wire.

71. A system according to examples 66, 67 or 68, wherein each of the plurality of heating elements is a coil.

72. A system according to any one of examples 61 to 71, wherein the deposition liquid is a solution.

73. A system according to any one of examples 61 to 72, wherein the deposition liquid comprises water.

74. A system according to any one of examples 61 to 73, wherein the deposition liquid comprises a saccharide.

75. A system according to example 74, wherein the saccharide comprises a monosaccharide.

76. A system according to examples 74 or 75, wherein the saccharide comprises a polysaccharide.

77. A system according to example 76, wherein the polysaccharide comprises sodium alginate.

78. A system according to example 76, wherein the polysaccharide is a cellulose derivative.

79. A system according to any one of examples 61 to 78, wherein the deposition liquid comprises sodium alginate and calcium carbonate.

80. A system according to any one of examples 61 to 78, wherein the deposition liquid comprises sodium alginate and iron(II).

81. A system according to any one of examples 61 to 80, wherein the deposition liquid comprises a flavourant.

82. A system according to any one of examples 61 to 81, wherein the deposition liquid comprises nicotine.

83. A system according to any one of examples 61 to 82, wherein the deposition liquid comprises an aerosol former.

84. A system according to example 83, wherein the aerosol former comprises vegetable glycerine.

85. A system according to examples 83 or 84, wherein the aerosol former comprises propylene glycol.

86. A system according to any one of examples 61 to 85, wherein the deposition liquid comprises an acid.

87. A system according to example 86, wherein the acid comprises lactic acid.

88. A system according to any one of examples 61 to 87, wherein the auxiliary electrode comprises silver.

89. A system according to any one of examples 61 to 88, wherein the auxiliary electrode comprises silver chloride.

90. A system according to any one of examples 61 to 89, wherein the system further comprises a cartridge of an aerosol-generating system, and wherein the cartridge comprises the heating element.

91. A system according to example 90, wherein the cartridge comprises the auxiliary electrode.

92. A system according to examples 90 or 91, wherein the cartridge comprises a mouthpiece.

93. A system according to examples 90, 91 or 92, wherein the cartridge is removably couplable to an aerosol-generating device of the aerosol-generating system.

94. A system according to example 93, wherein the aerosol-generating device comprises a power supply arranged to supply power to the heating element when the cartridge is coupled to the aerosol-generating device to heat the aerosol-forming substrate deposited on the heating element to generate an aerosol from the aerosol-forming substrate.

95. A system according to any one of examples 61 to 89, wherein the system comprises an aerosol-generating device, and wherein the aerosol-generating device comprises the heating element.

96. A system according to example 95, wherein the heating element is removably couplable to the aerosol-generating device.

97. A system according to example 95, wherein the heating element an integral part of the aerosol-generating device.

98. A system according to examples 95, 96 or 97, wherein the aerosol-generating device comprises the auxiliary electrode.

99. A system according to any one of examples 95 to 98, wherein the aerosol-generating device comprises a power supply arranged to supply power to the heating element to heat the aerosol-forming substrate deposited on the heating element to generate an aerosol from the aerosol-forming substrate.

100. A system according to examples 94 or 99, wherein the aerosol-generating device comprises a controller configured to control the supply of power from the power supply to the heating element.

101. A system according to example 100, wherein the controller is configured to control the supply of power from the power supply to the heating element to deposit an aerosol-forming substrate on the heating element by electrophoretic deposition when the heating element and the auxiliary electrode are submerged in the deposition liquid.

102. A system according to examples 100 or 101, wherein the controller is configured to control the supply of power from the power supply to the auxiliary electrode.

103. A system according to example 102, wherein the controller is configured to control the supply of power from the power supply to the auxiliary electrode to deposit an aerosol-forming substrate on the heating element by electrophoretic deposition when the heating element and the auxiliary electrode are submerged in the deposition liquid.

104. A system according to any one of examples 61 to 103, wherein the system further comprises a reference electrode, and wherein the system is configured to supply a voltage between the heating element, the auxiliary electrode, and the reference electrode to deposit an aerosol-forming substrate on the heating element by electrophoretic deposition when at least a portion of the heating element, at least a portion of the auxiliary electrode and at least a portion of the reference electrode are submerged in the deposition liquid.

105. A system according to any one of examples 94 or 99 to 103, wherein the system further comprises a reference electrode, wherein the system is configured to supply a voltage between the heating element, the auxiliary electrode, and the reference electrode from the power supply of the aerosol-generating device to deposit an aerosol-forming substrate on the heating element by electrophoretic deposition when at least a portion of the heating element, at least a portion of the auxiliary electrode and at least a portion of the reference electrode are submerged in the deposition liquid.

106. A system according to any one of examples 90 to 94, wherein the cartridge further comprises a reference electrode, wherein the system is configured to supply a voltage between the heating element, the auxiliary electrode, and the reference electrode to deposit an aerosol-forming substrate on the heating element by electrophoretic deposition when at least a portion of the heating element, at least a portion of the auxiliary electrode and at least a portion of the reference electrode are submerged in the deposition liquid.

107. A system according to any one of examples 93 to 99, wherein the aerosol-generating device further comprises a reference electrode, wherein the system is configured to supply a voltage between the heating element, the auxiliary electrode, and the reference electrode to deposit an aerosol-forming substrate on the heating element by electrophoretic deposition when at least a portion of the heating element, at least a portion of the auxiliary electrode and at least a portion of the reference electrode are submerged in the deposition liquid.

108. A system according to any one of examples 104 to 107, wherein the reference electrode comprises platinum.

109. A system according to any one of examples 61 to 108, wherein the system further comprises a deposition device, and the deposition liquid is held in the deposition device.

110. A system according to any one of examples 61 to 90 or 95 to 97, wherein the system further comprises a deposition device, wherein the deposition liquid is held in the deposition device, and wherein the deposition device comprises the auxiliary electrode.

111. A system according to any one of examples 61 to 101, wherein the system further comprises a deposition device, wherein the deposition liquid is held in the deposition device, and wherein the deposition device comprises a power supply arranged to supply a voltage between the heating element and the auxiliary electrode to deposit an aerosol-forming substrate on the heating element by electrophoretic deposition.

112. A system according to any one of examples 61 to 90 or 95 to 97, wherein the system further comprises a deposition device, wherein the deposition liquid is held in the deposition device and the deposition device comprises the auxiliary electrode, and wherein the deposition device comprises a power supply arranged to supply a voltage between the heating element and the auxiliary electrode to deposit an aerosol-forming substrate on the heating element by electrophoretic deposition.

113. A system according to any one of examples 61 to 103, wherein the system further comprises a deposition device and a reference electrode, wherein the deposition liquid is held in the deposition device and the deposition device comprises the reference electrode, and wherein the system is configured to supply a voltage between the heating element, the auxiliary electrode, and the reference electrode to deposit an aerosol-forming substrate on the heating element by electrophoretic deposition.

114. A system according to any one of examples 110, 111 or 112, wherein the system further comprises a deposition device and a reference electrode, wherein the deposition device comprises the reference electrode, and wherein the deposition device comprises a power supply arranged to supply a voltage between the heating element, the auxiliary electrode, and the reference electrode to deposit an aerosol-forming substrate on the heating element by electrophoretic deposition when at least a portion of the heating element, at least a portion of the auxiliary electrode and at least a portion of the reference electrode are submerged in the deposition liquid.

115. A system according to examples 113 or 114, wherein the deposition device comprises the auxiliary electrode.

116. A system according to any one of examples 109 to 112, wherein the deposition device comprises a controller configured to control the supply of voltage between the heating element and the auxiliary electrode.

117. A system according to examples 113, 114 or 115, wherein the deposition device comprises a controller configured to control the supply of voltage between the heating element, the auxiliary electrode, and the reference electrode.

118. A system according to any one of examples 1 to 117, wherein the system further comprises a cleaner configured to remove aerosol-forming substrate from the heating element.

119. A system according to any one of examples 109 to 118, wherein the deposition device further comprises a cleaner configured to remove aerosol-forming substrate from the heating element.

120. A system according to examples 118 or 119, wherein the cleaner comprises a brush.

121. A system according to examples 118, 119, or 120, wherein the cleaner comprises a scraper.

122. A system according to any one of examples 118 to 121, wherein the cleaner comprises a cleaning liquid.

123. A system according to example 119, wherein the deposition device comprises a cleaning compartment comprising a cleaning cavity configured to receive the heating element, the cleaning cavity holding a cleaning liquid.

124. A system according to examples 122 or 123, wherein the cleaning liquid comprises an acid.

125. A system according to example 122, wherein the cleaning liquid is the deposition liquid, and the deposition device is configured to be electrically coupled to the heating element and supply a voltage between the heating element and the auxiliary electrode when the heating element is received in the cleaning liquid to electrically clean the heating element.

126. A system according to examples 123, wherein the cleaning liquid is a deposition liquid, the deposition device comprises a cleaning auxiliary electrode arranged in the cleaning liquid, and the deposition device is configured to be electrically coupled to the heating element and supply a voltage between the heating element and the auxiliary electrode when the heating element is received in the cleaning liquid to electrically clean the heating element.

127. A deposition device comprising a housing defining a cavity holding a deposition liquid.

128. A deposition device according to example 127, wherein the deposition device is configured to be electrically coupled a heating element of an aerosol-forming system.

129. A deposition device according to example 128, further comprising an auxiliary electrode arranged in the cavity and at least partially submerged in the deposition liquid.

130. A deposition device according to example 129, further comprising a power supply arranged to supply a voltage between the heating element and the auxiliary electrode to deposit an aerosol-forming substrate on the heating element when the heating element is electrically coupled to the deposition device, and at least a portion of the heating element is submerged in the deposition liquid.

131. A deposition device according to example 129, further comprising a reference electrode arranged in the cavity and at least partially submerged in the deposition liquid.

132. A deposition device according to example 131, further comprising a power supply arranged to supply a voltage between the heating element, the auxiliary electrode, and the reference electrode to deposit an aerosol-forming substrate on the heating element when the heating element is electrically coupled to the deposition device, and at least a portion of the heating element is submerged in the deposition liquid.

133. A deposition device according to examples 130 or 132, further comprising a controller to control the supply of power from the power supply.

134. A deposition device according to example 127, wherein the deposition device is configured to receive at least a portion of a heating element of an aerosol-generating system in the cavity, the heating element being at least partially submerged in the deposition liquid when the heating element is received in the cavity.

135. A deposition device according to examples 127, wherein the deposition device is configured to receive at least a portion of a cartridge of an aerosol-generating system in the cavity, the cartridge comprising a heating element that is at least partially submerged in the deposition liquid when the cartridge is received in the cavity.

136. A deposition device according to examples 127, wherein the deposition device is configured to receive at least a portion of an aerosol-generating device in the cavity, the aerosol-generating device comprising a heating element that is at least partially submerged in the deposition liquid when the cartridge is received in the cavity.

137. A deposition device according to any one of examples 127 to 136, wherein the deposition liquid is a solution.

138. A deposition device according to any one of examples 127 to 137, wherein the deposition liquid comprises water.

139. A deposition device according to any one of examples 127 to 138, wherein the deposition liquid comprises a saccharide.

140. A deposition device according to example 139, wherein the saccharide comprises a monosaccharide.

141. A deposition device according to examples 139 or 140, wherein the saccharide comprises a polysaccharide.

142. A deposition device according to example 141, wherein the polysaccharide comprises sodium alginate.

143. A deposition device according to example 141, wherein the polysaccharide is a cellulose derivative.

144. A deposition device according to any one of examples 127 to 143, wherein the deposition liquid comprises sodium alginate and calcium carbonate.

145. A deposition device according to any one of examples 127 to 143, wherein the deposition liquid comprises sodium alginate and iron(II).

146. A deposition device according to any one of examples 127 to 145, wherein the deposition liquid comprises a flavourant.

147. A deposition device according to any one of examples 127 to 146 wherein the deposition liquid comprises nicotine.

148. A deposition device according to any one of examples 127 to 147, wherein the deposition liquid comprises at least one aerosol former.

149. A deposition device according to example 148, wherein the aerosol former comprises vegetable glycerine.

150. A deposition device according to examples 147 or 149, wherein the aerosol former comprises propylene glycol.

151. A deposition device according to any one of examples 127 to 150, wherein the deposition liquid comprises an acid.

152. A deposition device according to example 151, wherein the acid comprises lactic acid.

153. An aerosol-generating device comprising:
a heating element;
an auxiliary electrode;
a power supply arranged to supply power to the heating element, and supply a voltage between the heating element and the auxiliary electrode; and
a controller configured to:
control the supply of power to the heating element to heat an aerosol-forming substrate deposited on the heating element to generate an aerosol; and
control the supply of the voltage between the heating element and the auxiliary electrode.

154. An aerosol-generating device according to example 153, further comprising a reference electrode; wherein:
the power supply is arranged to supply a voltage between the heating element, the auxiliary electrode and the reference electrode; and
the controller is configured to control the supply of the voltage between the heating element, the auxiliary electrode, and the reference electrode.

155. A cartridge for an aerosol-generating system, the cartridge comprising:
a heating element; and
an auxiliary electrode.

156. A cartridge according to example 155, wherein an aerosol-forming substrate is deposited on the heating element.

157. A cartridge according to examples 155 or 156, further comprising a reference electrode.

Embodiments of the present disclosure will now be described, by way of example only, with reference to the accompanying drawings, in which:

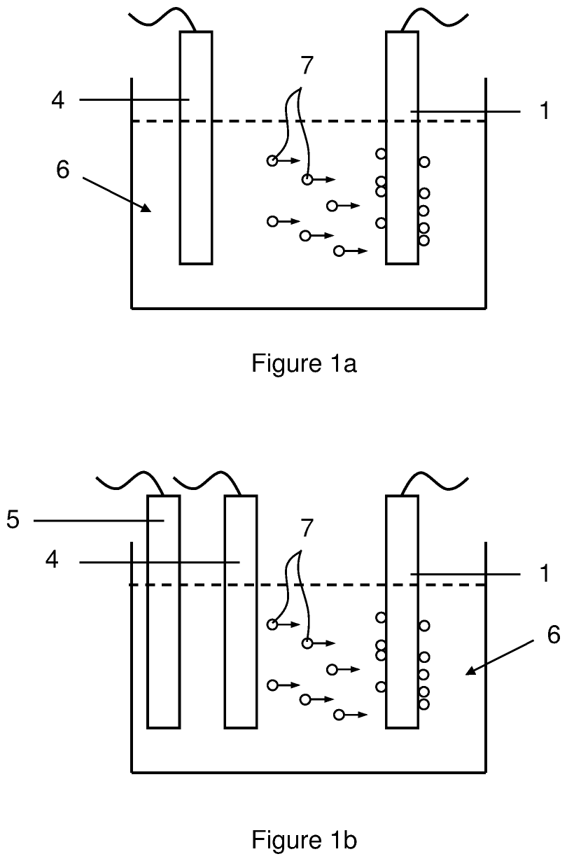

FIGS. 1a and 1b are schematic illustrations of simplified systems for forming an aerosol-generating component of an aerosol-generating system in accordance with this disclosure;

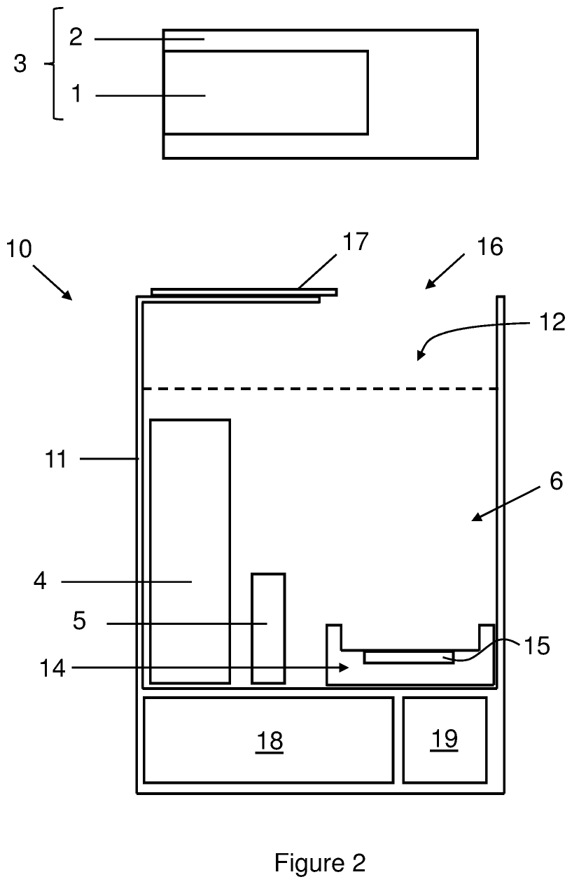

FIG. 2 is a schematic illustration of a heating element and a deposition device in accordance with this disclosure;

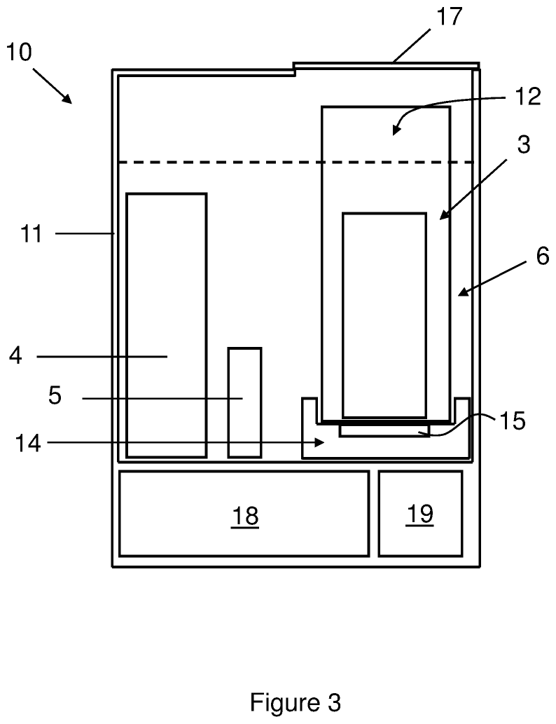

FIG. 3 is a schematic illustration of the heating element and deposition device of FIG. 2, wherein the heating element is received in the deposition device;

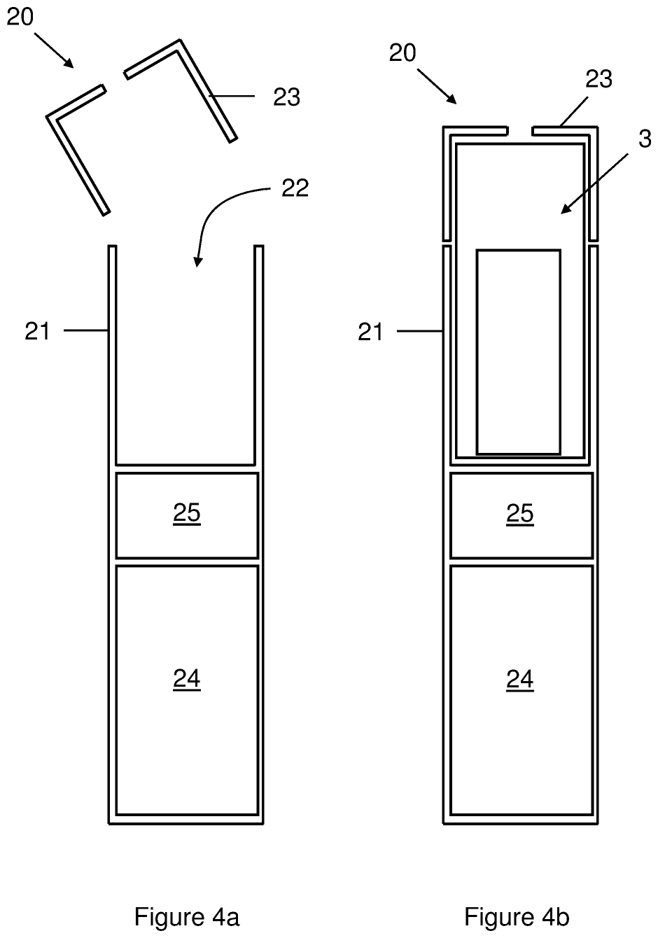

FIGS. 4a and 4b are schematic illustrations of an aerosol-generating system comprising an aerosol-generating device and the heating element of FIG. 2, in accordance with this disclosure;

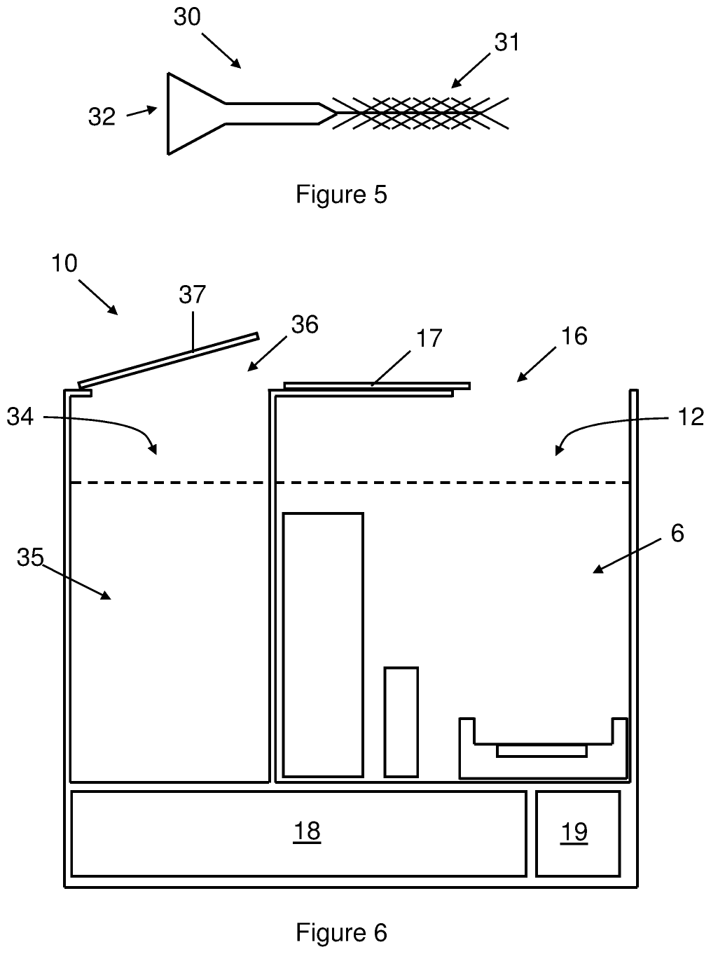

FIG. 5 is a schematic illustration of a cleaning device in accordance with this disclosure;

FIG. 6 is a schematic illustration of a deposition device including a cleaner in accordance with this disclosure;

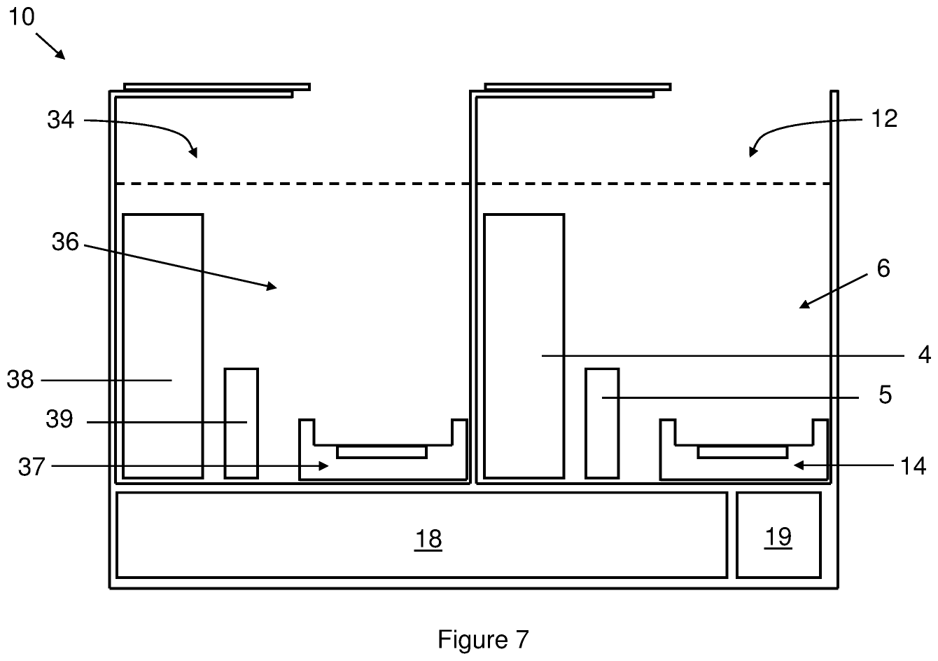

FIG. 7 is a schematic illustration of a deposition device including a cleaner in accordance with this disclosure;

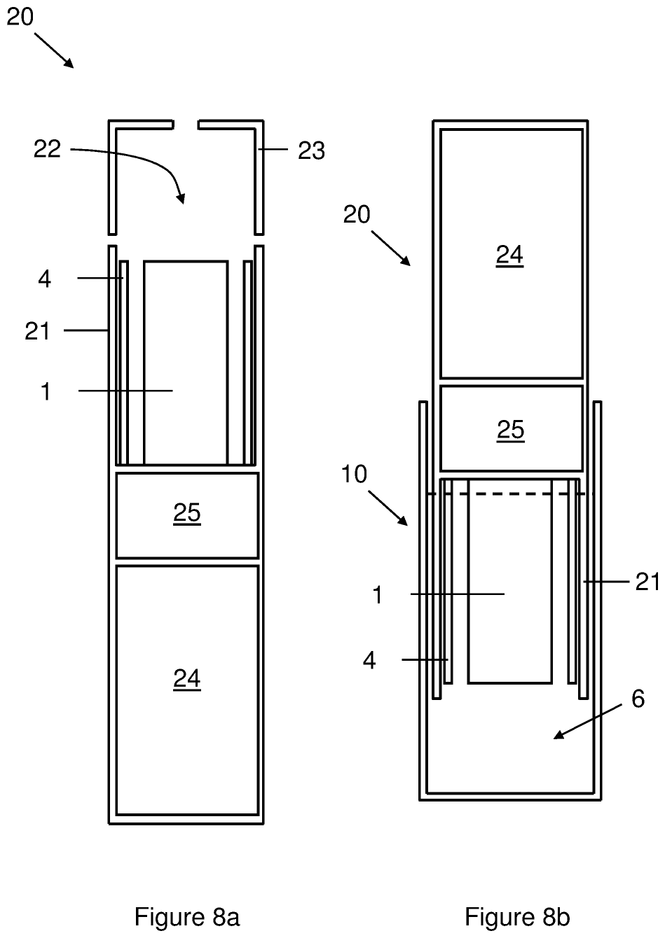

FIGS. 8a and 8b are schematic illustrations of an aerosol-generating device in accordance with this disclosure;

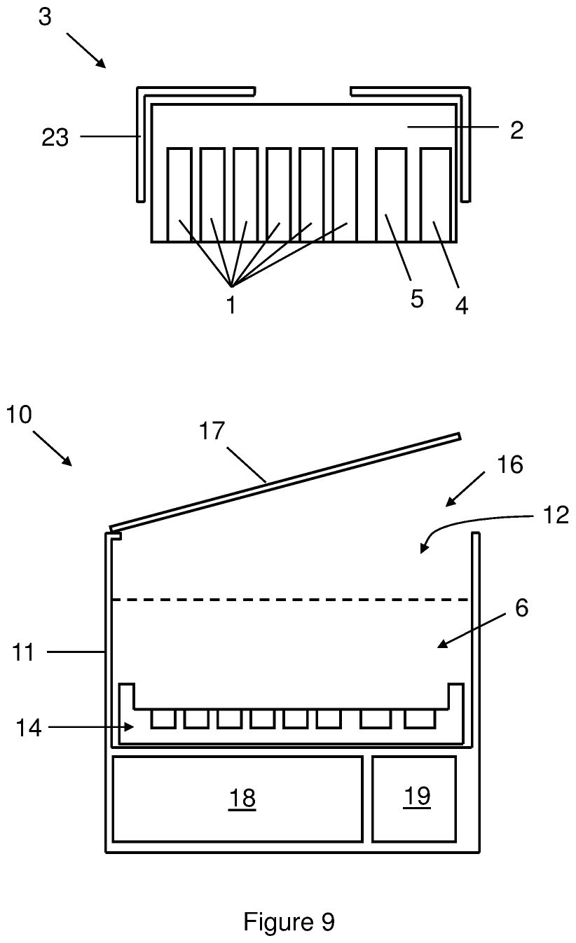

FIG. 9 is a schematic illustration of a cartridge for an aerosol-generating system and a deposition device in accordance with this disclosure;

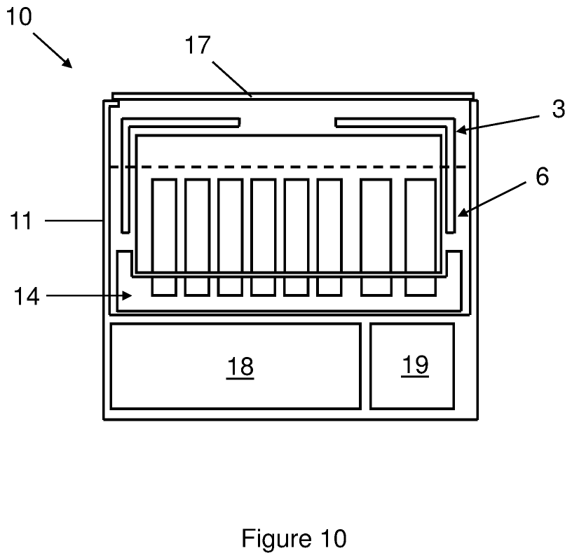

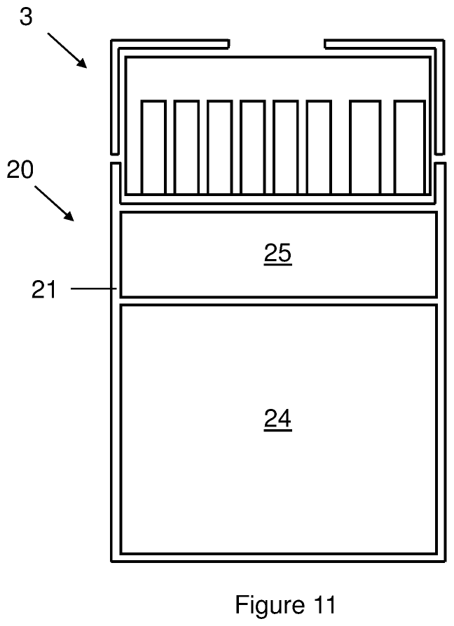

FIG. 10 is a schematic illustration of the cartridge and the deposition device of FIG. 9, wherein the cartridge is received in the deposition device; and

FIG. 11 is a schematic illustration of the cartridge of FIG. 9 and an aerosol-generating device, wherein the cartridge is received in the aerosol-generating device.

FIGS. 1a and 1b show two different systems for forming an aerosol-generating component of an aerosol-generating system according to this disclosure.

FIG. 1a shows a two electrode system for depositing an aerosol-forming substrate on a heating element by electrophoretic deposition to form an aerosol-generating component. The system comprises a heating element 1, which acts as a working electrode, and an auxiliary electrode 4. The heating element 1 is formed from platinum, and the auxiliary electrode 4 is formed from silver chloride. The heating element 1 and the auxiliary electrode 4 are partially submerged in a deposition liquid 6. The deposition liquid 6 is a solution comprising water as the solvent, sodium alginate (AlgNa), particles of calcium carbonate (CaCO₃), an aerosol-former in the form of propylene glycol, and nicotine. The deposition liquid comprises the desired components of the aerosol-forming substrate, which in this embodiment are propylene glycol (the aerosol former), water, and nicotine. It will be appreciated that in other embodiments, the deposition liquid may comprise different components. For example, the deposition liquid may comprise a different polysaccharide than sodium alginate. For example, the deposition liquid may comprise a different aerosol-former than propylene glycol. For example, the deposition liquid may comprise a different active ingredient than nicotine. For example, the deposition liquid may comprise one or more of a flavourant and an acid.

Each of the heating element 1 and the auxiliary electrode 4 are connected to a power supply (not shown), which is arranged to supply a voltage between the heating element 1 and the auxiliary electrode 4. A controller (not shown) controls the supply of power to the heating element 1, the auxiliary electrode 4. When the voltage is supplied between the heating element 1 and the auxiliary electrode 4, an electric field is established in the deposition liquid 6. The electric field in the deposition liquid 6 causes migration of charged particles 7 in the deposition liquid 6 towards the heating element 1. Charged particles 7 attracted to the heating element 1 are deposited on the surface of the heating element 1, forming a layer of aerosol-forming substrate on the surface of the heating element 1. For this deposition liquid 6, the sodium alginate in the deposition liquid 6 gelates at the heating element 1 to form a hydrogel that is deposited on the heating element 1. The hydrogel traps propylene glycol, water and nicotine, such that the hydrogel deposited on the heating element comprises the desired components for the aerosol-forming substrate.

FIG. 1b shows a three electrode system for forming an aerosol-generating component, comprising a heating element 1, which acts as a working electrode, an auxiliary electrode 4, and a reference electrode 5. The system of FIG. 1b is substantially similar to the system of FIG. 1a, and like features are denoted with like reference numerals. The system of FIG. 1b differs from the system of FIG. 1a only in that the system of FIG. 1b comprises the reference electrode 5. The reference electrode 5 is formed from platinum. The reference electrode 5 is partially submerged in the deposition liquid 6, and is connected to the power supply (not shown). The power supply is arranged to supply a voltage between the heating element 1, the auxiliary electrode 4, and the reference electrode 5.

A controller (not shown) controls the supply of power to the heating element 1, the auxiliary electrode 4, and the reference electrode 5. A stable and known voltage is supplied from the power supply to the auxiliary electrode 4. A voltage is supplied between the heating element 1 and the reference electrode 5, which is measured against the voltage supplied to the auxiliary electrode 4. The rate of electrical deposition of aerosol-forming substrate occurring at the heating element 1 is determined by the controller from the measured voltage between the reference electrode 5 and the auxiliary electrode 4, and the voltage between the reference electrode 5 and the heating element 1 is adjusted in response to the determined rate of electrical deposition of aerosol-forming substrate occurring at the heating element 1.

FIGS. 2-4 show a system for forming an aerosol-generating component of an aerosol-generating system according to this disclosure.

As shown in FIG. 2, the system comprises a heating element 1, provided on an electrically insulative substrate 2. The heating element 1 and electrically insulative substrate 2 form an aerosol-generating component 3 of the aerosol-generating system when aerosol-generating substrate is deposited on the heating element 1. The aerosol-generating component 3 may be considered to be a cartridge of the aerosol-generating system.

Also as shown in FIG. 2, the system comprises a deposition device 10. The deposition device 10 comprises a housing 11 defining a cavity 12 holding a deposition liquid 6. The deposition liquid 6 is the same deposition liquid as described above with reference to FIG. 1a.

A connector 14 for coupling the deposition device 10 to the aerosol-generating component 3 is arranged in the cavity 12, submerged in the deposition liquid 6. The connector 14 comprises an electrical contact pad 15 which is configured to electrically couple with the heating element 1 when the aerosol-generating component 3 is coupled to the connector. An auxiliary electrode 4, and a reference electrode 5 are also arranged in the cavity 16 and at least partially submerged in the deposition liquid 6.

The housing 11 further defines an opening 16 at an upper end of the deposition device 10 to enable the aerosol-generating component 3 to be inserted into the cavity 12. A closure 17 is slidably coupled to the housing 11 and is slidably movable between an open and a closed position. In the open position, the opening 16 is open to allow insertion of the aerosol-generating component 3 into the cavity 12, and removal of the aerosol-generating component 3 from the cavity 12. In the closed position, the closure 17 covers the opening 16 to prevent insertion of the aerosol-generating component 3 into the cavity 12 and removal of the aerosol-generating component 3 from the cavity 12. A liquid tight seal is provided between the closure 17 and the housing 11 in the closed position, so that the deposition liquid 6 cannot escape from the cavity 12 when the closure 17 is in the closed position. It will be appreciated that the closure 17 may be movable in any suitable manner between the open and closed position. In some embodiments, the closure 17 may be rotatably movable between the open position and the closed position. In some embodiments, the closure 17 may be removable from the housing 11.

The deposition device 10 further comprises a power supply 18, in the form of a rechargeable lithium ion battery. The power supply 18 is arranged to supply power to the electrical contact pad 15, the auxiliary electrode 4, and the reference electrode 5. The deposition device 10 further comprises a controller 19, which is configured to control the supply of power to the electrical contact pad 15, the auxiliary electrode 4, and the reference electrode 5.

FIG. 3 shows the aerosol-generating component 3 received in the cavity 12 of the deposition device 10, with the closure 17 in the closed position to prevent removal of the aerosol-generating component 3 from the cavity 12. The aerosol-generating component 3 is coupled to the connector 14 of the deposition device 10, and the heating element 1 is fully submerged in the deposition liquid 6, and is electrically coupled to the electrical contact pad 15. In this configuration, the system is ready to deposit aerosol-forming substrate onto the heating element 1 by electrophoretic deposition. The deposition device 10 and the aerosol-generating component 3 form a three electrode system, as described above with reference to FIG. 1b.

The deposition device 10 further comprises a switch (not shown). When the switch is activated by a user, the controller 19 supplies power to the electrical contact pad 15, which supplies power to the heating element 1, the auxiliary electrode 4, and the reference electrode 5. The controller supplies a voltage between the heating element 1, the auxiliary electrode 4, and the reference electrode 5 as described above with reference to FIG. 1b, to deposit an aerosol-forming substrate on the heating element by electrophoretic deposition 1.

FIG. 4a shows an aerosol-generating device 20, which is configured to couple with the aerosol-generating component 3 of FIGS. 2 and 3 to form an aerosol-generating system. The aerosol-generating device 20 comprises a housing 21, which defines a cavity 22 for receiving the aerosol-generating component 3. A mouthpiece 23 is removably couplable to the housing 21 of the aerosol-generating device 21, and covers the cavity 22 when coupled to the housing 21 to retain the aerosol-generating component 3 in the cavity 22. The aerosol-generating device 20 further comprises a power supply 24, in the form of a rechargeable lithium ion battery, which is arranged to be electrically coupled to the heating element 1 of the aerosol-generating component 3 when the aerosol-generating component 3 is received in the cavity 22. The aerosol-generating device 20 further comprises a controller 25, which controls the supply of power to the heating element 1 of the aerosol-generating component.

FIG. 4b shows the aerosol-generating system ready for use, with aerosol-forming substrate deposited on the heating element 1 by electrophoretic deposition of the aerosol-generating component 3, the aerosol-generating component 3 received in the cavity 22, and the mouthpiece 23 coupled to the housing 21. The aerosol-generating device 20 further comprises a puff sensor (not shown), which activates the aerosol-generating device 20 when it detects a user puffing on the mouthpiece 23. In use, when a user activates the device by puffing on the mouthpiece 23, the controller 25 supplies power from the power supply 24 to the heating element 1 to heat the aerosol-forming substrate to generate an aerosol, which is delivered to the user through the mouthpiece 23.

FIGS. 5, 6 and 7 show various cleaners configured to remove aerosol-forming substrate from a heating element of an aerosol-generating component.

FIG. 5 shows a cleaning device 30. The cleaning device 30 comprises a brush 31 at one end, for brushing aerosol-forming substrate off of a heating element. the cleaning device 30 further comprises a scraper 32 at the opposite end to the brush 31. The scraper is configured to scrape aerosol-forming substrate off of a heating element. The cleaning device 30 is configured to be used manually by a user. In other words, the user holds and operates the brush 31 and the scraper 32 with their hand. In use, a user cleans the heating element of the aerosol-generating component before proceeding to deposit new aerosol-forming substrate on the heating element by electrophoretic deposition.

FIG. 6 shows a deposition device 10 comprising a cleaner. The deposition device 10 is substantially the same as the deposition device 10 described above with reference to FIGS. 2 and 3, and like reference numerals are used to describe like features. The deposition device 10 of FIG. 6 differs from the deposition device 10 of FIGS. 2 and 3 only in that the deposition device 10 of FIG. 6 comprises a cleaner.

The cleaner of the deposition device 10 of FIG. 6 comprises a cleaning cavity 34 defined by the housing of the deposition device 10. The cleaning cavity 34 holds a cleaning liquid 35. In this embodiment, the cleaning liquid is a water based cleaning solution. It will be appreciated that any cleaning liquid suitable for removing aerosol-forming substrate from a heating element may be used. An opening 36 is provided in the housing to enable the aerosol-generating component 3 to be inserted into the cleaning compartment 34, and removed from the cleaning compartment 34. A closure 37 is also provided, and is rotatable between an open position and a closed position. In the open position, the cover 37 is rotated away from the opening 36 to enable an aerosol-generating component to be inserted into the cleaning cavity 34, and removed from the cleaning cavity 34. In the closed position, the cover 37 is rotated over the opening 36 to cover the opening 36 and prevent insertion of an aerosol-generating component into the cleaning cavity 34 and removal of an aerosol-generating component from the cleaning cavity 34. A liquid tight seal is provided between the housing of the deposition device and the closure 37 in the closed position to prevent the cleaning liquid from escaping from the cleaning compartment 34.

FIG. 7 also shows a deposition device 10 comprising a cleaner. The deposition device 10 is substantially the same as the deposition device 10 described above with reference to FIGS. 2 and 3, and like reference numerals are used to describe like features. The deposition device 10 of FIG. 7 differs from the deposition device 10 of FIGS. 2 and 3 only in that the deposition device 10 of FIG. 7 comprises a cleaner.

The cleaner of the deposition device 10 of FIG. 7 comprises a cleaning cavity 34 defined by the housing of the deposition device 10. The cleaning cavity 34 is substantially similar to the cavity 12, and is provided with a similar opening and closure. The cleaning cavity 34 holds a cleaning liquid 36. In this embodiment, the cleaning liquid is a deposition liquid, which similar to the deposition liquid 6 in the cavity 12. A connector 37, with an electrical contact pad, an auxiliary electrode 38, and a reference electrode 39 are provided in the cleaning cavity 34, submerged in the cleaning liquid 36. The connector 37, auxiliary electrode 38 and reference electrode 39 are identical to the connector 14, auxiliary electrode 4, and reference electrode 5 in the cavity 12, and are similarly connected to the power supply 18 and the controller 19. The controller is configured to control the supply of voltage between the heating element of the aerosol-generating component connected to the connector 37, the auxiliary electrode 38, and the reference electrode 39 to clean aerosol-forming substrate from the heating element. The voltage supplied between the heating element of the aerosol-generating component connected to the connector 37, the auxiliary electrode 38, and the reference electrode 39 is generally opposite to the voltage supplied between the heating element of the aerosol-generating component connected to the connector 14, the auxiliary electrode 4, and the reference electrode 5 to deposit aerosol-forming substrate on the heating element by electrophoretic deposition. Such a voltage establishes an electric field in the deposition liquid which causes the aerosol-forming substrate on the heating element to migrate away from the heating element.

FIGS. 8a and 8b show a system for forming an aerosol-generating component of an aerosol-generating system according to this disclosure. The system comprises a deposition device 10, and an aerosol-generating device 20.

As shown in FIG. 8b, the deposition device 10 in this embodiment comprises a container holding a deposition liquid 6. The deposition liquid 6 is the same deposition liquid as described above with reference to FIG. 1a. The container of the deposition device 10 is sized to receive a portion of the aerosol-generating device 20, as shown in FIG. 8b.

As shown in FIG. 8a, the aerosol-generating device 20 comprises a housing 21, which defines a cavity 22 comprising a heating element 1, and an auxiliary electrode 4. The heating element 1 comprises a planar sheet of platinum, and the auxiliary electrode 4 comprises a layer of silver chloride applied to the inner surface of the housing 21 defining the cavity 22. The auxiliary electrode 4 circumscribes the heating element 1, with a gap between the heating element 1 and the auxiliary electrode 4 to accommodate deposition liquid 6 when the aerosol-generating device 20 is received in the deposition device 10. The heating element 1 and the auxiliary electrode 4 form a two electrode system, as described above with reference to FIG. 1a.

The aerosol-generating device 20 further comprises a mouthpiece 23, which is removably couplable to the housing 21 of the aerosol-generating device 20, and covers the cavity 22 when coupled to the housing 21. The mouthpiece 23 is removable so that the mouthpiece does not come into contact with the deposition liquid 6 when the aerosol-generating device 20 is received in the deposition device 10.

The aerosol-generating device 20 further comprises a power supply 24, in the form of a rechargeable lithium ion battery, which is electrically coupled to the heating element 1 and the auxiliary electrode 4. The aerosol-generating device 20 further comprises a controller 25, which controls the supply of power to the heating element 1, and the auxiliary electrode 4. The controller 25 is configured to control the supply of power to the heating element 1 to heat an aerosol-forming substrate deposited on the surface of the heating element 1 by electrophoretic deposition to form an aerosol. The controller 25 is also configured to supply a voltage between the heating element 1 and the auxiliary electrode 4 to deposit an aerosol-forming substrate on the heating element 1 by electrophoretic deposition when the aerosol-generating device 20 is received in the deposition device 10, and at least a portion of the heating element and a portion of the auxiliary electrode are submerged in the deposition liquid 6.

The aerosol-generating device 20 further comprises a puff sensor (not shown), which activates the device when it detects a user puffing on the mouthpiece 23. In use, when the mouthpiece 23 is coupled to the housing 21, and when a user activates the device by puffing on the mouthpiece 23, the controller 25 supplies power from the power supply 24 to the heating element 1 to heat the aerosol-forming substrate to generate an aerosol, which is delivered to the user through the mouthpiece 23.

To prepare the aerosol-generating device 20 for use, the mouthpiece 23 is uncoupled from the housing 21, and a proximal end of the aerosol-generating device 20 is inserted into the container of the deposition device 10 and submerged in the deposition liquid 6. The proximal end of the aerosol-generating device 20 comprises the cavity 22, the heating element 1, and the auxiliary electrode 4. When the proximal end of the aerosol-generating device 20 is submerged in the deposition liquid 6, the heating element 1 and the auxiliary electrode 4 are also submerged in the deposition liquid 6. The deposition device 10 and the aerosol-generating device 20 form a two electrode system, as described above with reference to FIG. 1a. The aerosol-generating device 20 further comprises a switch (not shown), which enables a user to instruct the controller 25 to supply a voltage between the heating element 1 and the auxiliary electrode 4 to deposit an aerosol-forming substrate on the heating element 1 by electrophoretic deposition. When the proximal end of the aerosol-generating device 20 is submerged in the deposition liquid 6, the user activates the switch to deposit aerosol-forming substrate on the heating element 1 by electrophoretic deposition. When aerosol-forming substrate is deposited on the heating element 1 by electrophoretic deposition, the heating element 1 and the aerosol-forming substrate form an aerosol-generating component, and the aerosol-generating device 20 forms an aerosol-generating system that is ready for use.

FIGS. 9, 10 and 11 show a system for forming an aerosol-generating component of an aerosol-generating system according to this disclosure.

As shown in FIG. 9, the system comprises a plurality of heating elements 1, provided on an electrically insulative substrate 2. In this embodiment, the plurality of heating elements 1 comprise six heating elements, spaced apart from each other at regular intervals across the electrically insulative substrate 2. Each heating element 1 comprises a rectangular strip of platinum. An auxiliary electrode 4 is arranged at one end of the electrically insulative substrate 2. The auxiliary electrode 4 comprises a rectangular sheet of silver chloride. A reference electrode 5 is arranged adjacent to the auxiliary electrode 4 on the electrically insulative substrate 2. The reference electrode 5 comprises a rectangular strip of platinum. The plurality of heating elements 1, electrically insulative substrate 2, auxiliary electrode 4, and reference electrode 5 are housed within a mouthpiece 23. The mouthpiece is configured to enable a user to puff on the mouthpiece to receive aerosol. The plurality of heating elements 1, electrically insulative substrate 2, auxiliary electrode 4, reference electrode 5 and mouthpiece 23 form an aerosol-generating component 3 of the aerosol-generating system when aerosol-generating substrate is deposited on the plurality of heating elements 1. The aerosol-generating component 3 may be considered to be a cartridge that is couplable to an aerosol-generating device to form an aerosol-generating system, as shown in FIG. 11.

The system for forming an aerosol-generating component further comprises a deposition device 10, as shown in FIG. 9. The deposition device 10 is substantially similar to the deposition device 10 described above with reference to FIG. 2, and like features are denoted with like reference numerals.

The deposition device 10 of FIG. 9 comprises a housing 11 defining a cavity 12 holding a deposition liquid 6. The deposition liquid 6 is the same deposition liquid as described above with reference to FIG. 1a.

A connector 14 for coupling the deposition device 10 to the cartridge 3 is arranged in the cavity 12, submerged in the deposition liquid 6. The connector 14 comprises a plurality of electrical contact pads configured to electrically couple with the plurality of heating elements 1, the auxiliary electrode 4, and the reference electrode 5 of the cartridge 3 when the cartridge is coupled to the connector 14.

The housing 11 further defines an opening 16 at an upper end of the deposition device 10 to enable the cartridge 3 to be inserted into the cavity 12. A closure 17 is rotatably coupled to the housing 11 and is rotatably movable between an open and a closed position. In the open position, the opening 16 is open to allow insertion of the cartridge 3 into the cavity 12, and removal of the cartridge 3 from the cavity 12. In the closed position, the closure 17 covers the opening 16 to prevent insertion of the cartridge 3 into the cavity 12 and removal of the cartridge 3 from the cavity 12. A liquid tight seal is provided between the closure 17 and the housing 11 in the closed position, so that the deposition liquid 6 cannot escape from the cavity 12 when the closure 17 is in the closed position.

The deposition device 10 further comprises a power supply 18, in the form of a rechargeable lithium ion battery. The power supply 18 is arranged to supply power to the electrical contact pad 15 of the connector 14. The deposition device 10 further comprises a controller 19, which is configured to control the supply of power to the electrical contact pads 15.

FIG. 10 shows the cartridge 3 received in the cavity 12 of the deposition device 10, with the closure 17 in the closed position to prevent removal of the cartridge 3 from the cavity 12. The cartridge 3 is coupled to the connector 14 of the deposition device 10, and the plurality of heating elements 1, the auxiliary electrode 4, and the reference electrode 5 are fully submerged in the deposition liquid 6, and are each electrically coupled to one of the electrical contact pads of the connector 14. In this configuration, the system is ready to deposit aerosol-forming substrate onto each of the plurality of heating elements 1 by electrophoretic deposition. The deposition device 10 and the cartridge 3 form a three electrode system, as described above with reference to FIG. 1b.

The deposition device 10 further comprises a switch (not shown). When the switch is activated by a user, the controller 19 supplies power to the electrical contact pads, which supplies power to each of the plurality of heating elements 1, the auxiliary electrode 4, and the reference electrode 5. The controller supplies a voltage between the auxiliary electrode 4 and the plurality of heating elements 1, and the reference electrode 5 and the plurality of heating elements 1, as described above with reference to FIG. 1b, to deposit aerosol-forming substrate on each one of the plurality of heating elements 1 by electrophoretic deposition.

FIG. 11 shows an aerosol-generating device 20, which is configured to couple with the cartridge 3 of FIGS. 9 and 10 to form an aerosol-generating system. The aerosol-generating device 20 comprises a housing 21, which is configured to couple with the cartridge 3. The aerosol-generating device 20 further comprises a power supply 24, in the form of a rechargeable lithium ion battery, which is arranged to electrically couple to each one of the plurality of heating elements 1 of the cartridge when the cartridge 3 is coupled to the aerosol-generating device 20. The aerosol-generating device 20 further comprises a controller 25, which is configured to selectively control the supply of power from the power supply 24 to each one of the plurality of heating elements 1 of the cartridge.

FIG. 11 shows the aerosol-generating system ready for use, with aerosol-forming substrate deposited on each one of the plurality of heating elements 1 of the cartridge 3 by electrophoretic deposition, and the cartridge 3 coupled to the aerosol-generating device 20. The aerosol-generating device 20 further comprises a puff sensor (not shown), which activates the aerosol-generating device 20 when it detects a user puffing on the mouthpiece 23. In use, when a user activates the device by puffing on the mouthpiece 23, the controller 25 selectively supplies power from the power supply 24 to each one of the plurality of heating elements 1 to heat the aerosol-forming substrate deposited on the heating element by electrophoretic deposition to generate an aerosol, which is delivered to the user through the mouthpiece 23.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5% of A.

1. A method of forming an aerosol-generating component of an aerosol-generating system, the method comprising:
submerging at least a portion of a heating element in a deposition liquid;
submerging at least a portion of an auxiliary electrode in the deposition liquid; and
supplying a voltage between the heating element and the auxiliary electrode to deposit an aerosol-forming substrate on the heating element by electrophoretic deposition.

2. A method according to claim 1, wherein the deposition liquid comprises a polysaccharide, and optionally one or more of:
water;
nicotine;
a flavourant;
an aerosol former; and
an acid.

3. A method according to claim 1, wherein the deposition liquid comprises sodium alginate, and optionally one or more of:
calcium carbonate; and
iron(II).

4. A method according to claim 1, further comprising submerging a reference electrode in the deposition liquid, and wherein the step of supplying a voltage comprises supplying a voltage between the heating element, the auxiliary electrode, and the reference electrode to deposit an aerosol-forming substrate on the heating element by electrophoretic deposition.

5. A method according to claim 1, further comprising the step of cleaning the heating element, and optionally wherein the step of cleaning the heating element comprises at least one of:
brushing the heating element with a brush;
scraping the heating element with a scraper;
submerging at least a portion of the heating element in a cleaning liquid; and
electrically cleaning the heating element by:
submerging a cleaning auxiliary electrode in the cleaning liquid;
submerging at least a portion of the heating element in the cleaning liquid; and
supplying a voltage between the heating element and the cleaning auxiliary electrode to electrically clean aerosol-forming substrate from the heating element.

6. A system for forming an aerosol-generating component of an aerosol-generating system, the system comprising:
a heating element;
an auxiliary electrode; and
a deposition liquid,
wherein the system is configured to supply a voltage between the heating element and the auxiliary electrode to deposit an aerosol-forming substrate on the heating element by electrophoretic deposition when at least a portion of the heating element and at least a portion of the auxiliary electrode are submerged in the deposition liquid.

7. A system according to claim 7, wherein the deposition liquid comprises a polysaccharide, and optionally one or more of:
water;
nicotine;
a flavourant;
an aerosol former; and
an acid.

8. A system according to claim 6, wherein the deposition liquid comprises sodium alginate, and optionally one or more of:
calcium carbonate; and
iron(II).

9. A system according to claim 6, further comprising a reference electrode, and wherein the system is configured to supply a voltage between the heating element, the auxiliary electrode and the reference electrode when at least a portion of the heating element, at least a portion of the auxiliary electrode, and at least a portion of the reference electrode are submerged in the deposition liquid to deposit an aerosol-forming substrate on the heating element by electrophoretic deposition.

10. A system according to claim 6, wherein the system further comprises a cleaner configured to remove aerosol-forming substrate from the heating element, and optionally wherein the cleaner comprises at least one of:
a brush;
a scraper;
a cleaning liquid; and
an electrical cleaning arrangement, comprising:
a cleaning liquid; and
a cleaning auxiliary electrode,
wherein the system is configured to supply a voltage between the heating element and the auxiliary cleaning electrode when at least a portion of the heating element and at least a portion of the cleaning auxiliary electrode are submerged in the cleaning liquid to remove aerosol-forming substrate from the heating element.

11. A system according to claim 6, wherein the system further comprises an aerosol-generating device, wherein the heating element is removably couplable to the aerosol-generating device, and wherein the aerosol-generating device comprises a power supply configured to supply power to the heating element when the heating element is coupled to the aerosol-generating device to heat the aerosol-forming substrate deposited on the heating element to generate an aerosol.

12. A system according to claim 6, wherein the system further comprises an aerosol-generating device, wherein the heating element is an integral part of the aerosol-generating device, and wherein the aerosol-generating device comprises a power supply configured to supply power to the heating element to heat the aerosol-forming substrate deposited on the heating element to generate an aerosol.

13. A system according to claim 11, wherein the aerosol-generating device further comprises the auxiliary electrode, and wherein the power supply of the aerosol-generating device is configured to supply the voltage between the heating element and the auxiliary electrode.

14. A system according to claim 6, wherein the system further comprises a deposition device the deposition device is configured to electrically couple to the heating element, and wherein:
the deposition device comprises:
a housing defining a cavity holding the deposition liquid;
the auxiliary electrode; and
a power supply arranged to supply the voltage between the heating element and the auxiliary electrode when the heating element is electrically coupled to the deposition device.

15. A deposition device configured to be electrically coupled a heating element of an aerosol-forming system, the deposition device comprising:
a housing defining a cavity holding a deposition liquid;
an auxiliary electrode arranged in the cavity and at least partially submerged in the deposition liquid; and
a power supply arranged to supply a voltage between the heating element and the auxiliary electrode to deposit an aerosol-forming substrate on the heating element when the heating element is electrically coupled to the deposition device, and at least a portion of the heating element is submerged in the deposition liquid.
